(19) United States
(12) Patent Application Publication
(10) Pub. No.: US 2007/0273756 A1
(43) Pub. Date: Nov. 29, 2007

(54) Apparatus and method for communication with eye contact

(76) Inventor: Eckhart Joachim Wintzen, Driebergen (NL)

Correspondence Address: MYERS DAWES ANDRAS & SHERMAN, LLP, 19900 MACARTHUR BLVD.,, SUITE 1150, IRVINE, CA, 92612, US

(21) Appl. No.: 10/581,020

(22) PCT Filed: Nov. 25, 2004
(86) PCT No.: PCT/NL04/00815

§ 371 Date: Feb. 21, 2007

(30) Foreign Application Priority Data
Nov. 27, 2003 (NL) 1024898

(51) Int. Cl. H04N 7/14

(52) U.S. Cl. 348/14.16

(57) ABSTRACT

The present invention provides a videophone for communication with eye contact, comprising a screen, a camera and a semi-transparent mirror. The screen is arranged at an angle ∝ relative to a support. The mirror lies at an angle of 45° relative to the screen, whereby the viewing axis is directed downward. At an angle ∝ up to 10° this has hardly any adverse consequences for communication. The advantage of the angle ∝ is however that the videophone, particularly in the closed position, takes up less space and is lower.

The present invention relates to an apparatus for communication with eye contact and a method for the use thereof. A videophone of applicant with the possibility of eye contact is known from WO-03/047253. Eye contact is important in communication in allowing non-verbal communication to function. Use of a videophone with eye contact approximates the feel of a physical encounter. This known videophone is thus suitable for instance for business consultation, so that internationally operating companies can save on travel costs. The known videophone has the drawback however that it is relatively high in closed situation. The screen thereof must also be covered with a special blocking foil, which is relatively costly, so as to prevent a secondary image.

The present invention has for its object to improve the known videophone and provides for this purpose an apparatus for communication with eye contact, comprising:
substantially flat image reproducing means for reproducing an image;
image recording means for recording an image;
mirror means arranged between the image reproducing means and the image recording means and comprising an at least partly light-transmitting, reflective surface for reflecting the image reproduced by the image reproducing means; and
a support, arranged on the underside of the image reproducing means, for supporting the apparatus on a surface therewith, wherein the image reproducing means form an acute angle α with the underside of the support.

Owing to the acute angle, the viewing axis from the eye of a user in the direction of the reflected image is no longer horizontal during use, but directed slightly downward. The thus introduced angle has the advantage that the videophone, particularly in closed position, is lower and therefore obstructs the view less in for instance an office. A second advantage of the acute angle is that the lying screen is tilted away from the user, whereby a foil for blocking a secondary image is unnecessary.

The acute angle is preferably in the order of 8°. This angle is found to be preferably suitable for obtaining the above stated advantages, wherein adverse effects on communication are prevented.

In a preferred embodiment the acute angle is smaller than or equal to 10′. Up to an angle of 10 the advantages of directing the viewing axis downward, such as the lower height, are greater than possible adverse effects such as the sensation of looking down on a conversation partner.

In a further preferred embodiment, the mirror means are arranged in open position at an angle β to the image reproducing means, wherein β is in the order of 45°. The construction of the videophone can be simplified considerably by giving angle β a fixed value.

In a preferred embodiment the mirror means are coupled in a pivot shaft to the image reproducing means, wherein the pivot axis extends as low as possible above the surface of the image reproducing means and at a predetermined distance from an edge of the image reproducing means. The effect of looking down on a user is compensated by placing the pivot shaft at some distance from the image reproducing means. The image reflected in the mirror means comes to lie in a higher position, so that the viewing axis also becomes more horizontal.

In a further preferred embodiment, the predetermined distance is greater than 80 mm. This is found to produce a sufficient raising of the image.

In a preferred embodiment the predetermined distance is in the order of 100 mm. At this distance the length of the apparatus is found to remain small enough for application in for instance an office environment.

In a preferred embodiment the image reproducing means comprise an LCD screen with an increased brightness of 1000-2000 Cd/m². The increased brightness produces an improved image quality with a better and brighter image after reflection.

In a further preferred embodiment, the at least partly light-transmitting reflective surface reflects about 50% of the incident light and allows through about 50% of the incident light. This ratio is found to be suitable for the desired application of video telephony.

In a preferred embodiment the apparatus comprises a coding/decoding unit for coding and decoding the recorded image and sound, and transmitting means for transmitting the coded image and sound. Due to encoding of the image signals, they can be transmitted via the internet. The transmitting means preferably use a bandwidth of 128 to 1024 kb/s.

According to a further aspect, the invention provides a method for use of the above described apparatus.

Further advantages and features are described hereinbelow with reference to the annexed figures, in which:

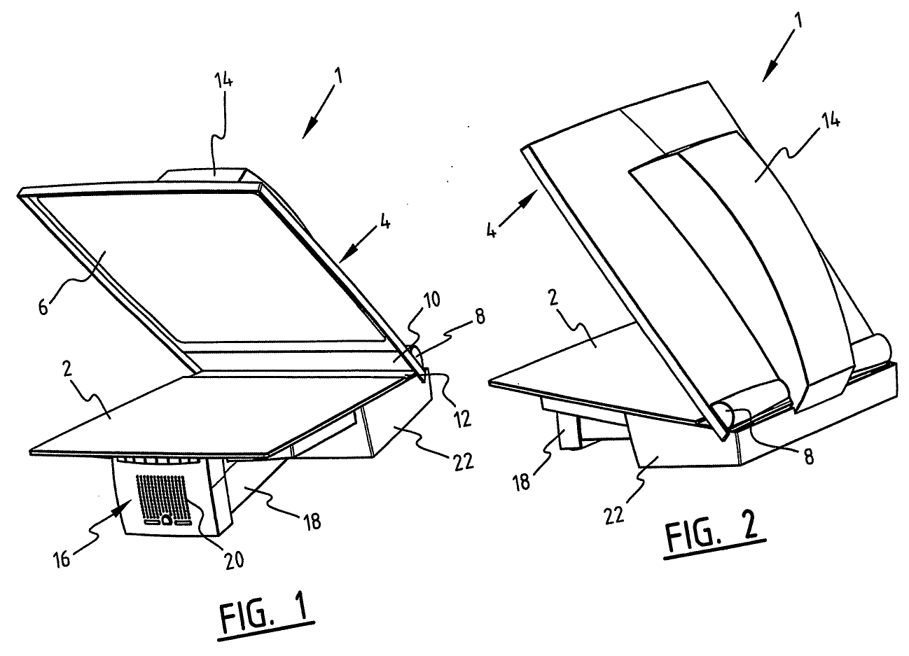

FIG. 1 shows a perspective front view of an apparatus according to the present invention in a first preferred embodiment;

FIG. 2 shows a perspective rear view of the apparatus of FIG. 1;

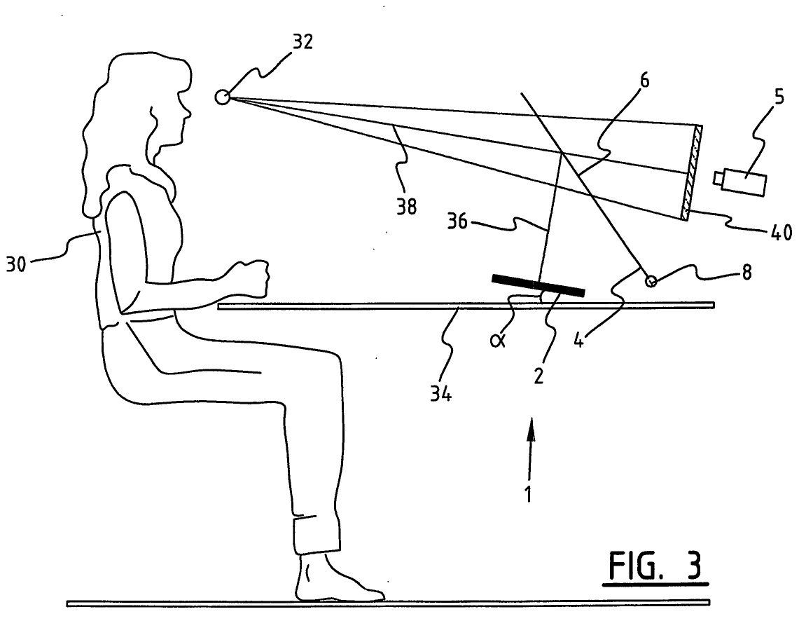

FIG. 3 shows a schematic side view of an apparatus according to the present invention;

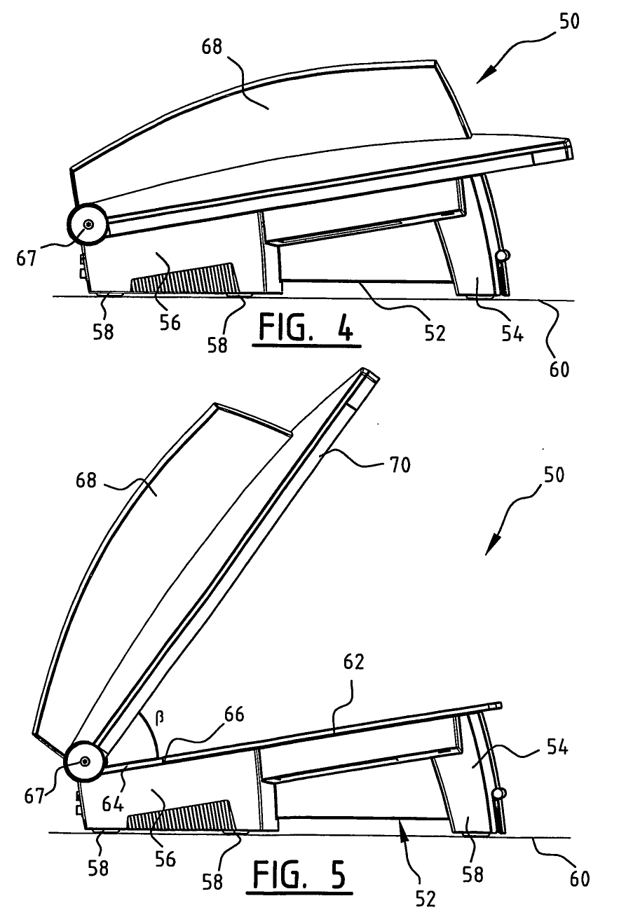

FIG. 4 shows a side view of an apparatus according to the present invention in a second preferred embodiment in a closed position; and

FIG. 5 is a side view of the apparatus of FIG. 4 in an opened position.

An apparatus 1 for communication with eye contact according to the present invention comprises image reproducing means 2, which for instance comprise an LCD screen, for reproducing a received image. Arranged hingedly relative to the image reproducing means is a flap 4 in which are arranged at least partly light-transmitting mirror means which comprise a partly transparent mirror 6. Flap 4 is connected hingedly to the image reproducing means in pivot shaft 8. Flap 4 can pivot from a closed position, wherein mirror 6 is rotated almost against the screen, to an open position as shown in FIG. 1. There is some space 10 on an underside of flap 4, between mirror surface 6 and pivot shaft 8. The intermediate space has a predetermined dimension which depends on the length of flap 4. Between an edge of the screen and pivot shaft 8 is arranged a second intermediate space 12, which partly determines the length of flap 4. Arranged behind mirror means 6 is a cover part 14 in which are situated image recording means 5 (shown in FIG. 3), such as a camera, for recording image.

On an underside of screen 2 is arranged a support 16 which is preferably wedge-shaped and which serves to place and support the apparatus on a surface, and which ensures that the screen forms a predetermined acute angle α with the underside of support 16. Support 16 comprises a front part 18 in which sound recording and reproducing means are arranged for respectively recording and reproducing sound. The sound recording and reproduction means comprise respectively a microphone and a loudspeaker which are coupled to a central processing unit (not further shown) and are arranged in front part 18 behind grid 20. Grid 20 is positioned such that (voice) sound comes from the direction of the position of a mouth of a face which is reproduced by screen 2 and which reflects in mirror 6. Support 16 further comprises a rear part 22 which is also wedge-shaped and which supports image reproducing means 2 over practically the whole width thereof for strengthening purposes in lateral direction (FIGS. 1, 2).

Apparatus 1 enables communication with eye contact since the mirror means comprise a semi-transparent mirror 6, which preferably reflects 50% of the light incident thereon and allows through 50% of the light incident thereon. The camera 5 shown in FIG. 3, which is arranged in cover 14 behind mirror 6, thus records the image of a user, while screen means 2 display the recorded image of a conversation partner. This displayed image is then reflected in mirror 6, whereby it is superimposed on the recorded image so that eye contact is possible. The sound reproducing and recording means further enable video telephony, wherein the recorded images and sounds are coded by a coding/decoding device arranged in support 16. The coded image and sound signals can then be transmitted via a network. For a desired image quality, these signals are transmitted at a bandwidth between 128 and 1024 kb/s. An LCD screen with an increased brightness is further used with a light intensity of 1000-2000 Cd/m². The image is thus found to retain a sufficient brightness after reflection for an improved and enhanced image quality.

Known videophones have the drawback of being relatively high to realize a horizontal viewing axis between users. The apparatus according to the present invention obviates this problem by arranging the screen at the acute angle α relative to the underside of support 18 (FIG. 3). Light from screen 2 is reflected in mirror 6 via lines 36 and 38 to point of vision 32 of a user 30.

The dimensions of the videophone are in the order of 100 to 250 mm high in closed position, about 200 to 800 mm wide and about 150 to 700 mm deep.

While in the opened position the height for a known videophone is roughly 600 mm relative to the surface 34, an angle α of 8° lowers the highest point of the mirror to about 510 mm. This point can be lowered further by increasing angle α. Angle α is preferably in the order of or smaller than 10°. The height of the videophone according to the present invention is then in the order of 300 to 500 mm.

Since the user is looking down, there is the danger that the person receiving the call has the sensation that he or she is being looked down on. In order to reflect the reflected image 40 at a higher position, the pivot shaft 8 is placed further to the rear from an edge of screen 2 (see also FIG. 5). By increasing the gap between the edge of the screen and the pivot shaft, and also by making the mirror, or the mirror means, longer, the image is reflected at a higher position.

In practice the videophone is positioned about 600 mm from a user, which is roughly equal to the eye level relative to desktop 34. The screen of the videophone is situated at a height of about 70 mm relative to the desktop and is about 300 mm deep. The viewing angle of a user relative to surface 34 is found to move upward through 6.5° in the case of a screen tilted to α=10° when the pivot shaft is displaced 100 mm to the rear from the edge of screen 100. The viewing angle can be displaced further to the rear and moves upward almost 9° at a displacement of 150 mm. The mirror, which is normally about 350 mm long, becomes proportionally longer. It is therefore recommended to set the gap 64 between edge 66 of the screen and the pivot shaft at about 100 mm.

The pivot shaft is also kept as low relative to an underside of the apparatus as the position of the image reproducing means allows. In the case of image reproducing means arranged close to the underside of the apparatus, the pivot shaft lies roughly in line with the surface of the image reproducing means. If the image reproducing means make an angle with the underside of the apparatus, the pivot shaft is then arranged such that it comes to lie directly above a surface or desktop, in the order of 1 to 5 cm, when the apparatus is placed thereon (FIG. 3).

A further problem of prior art apparatus is the secondary image which is caused in that a user not only sees the reflected image but also the image reproduced by screen 2. This was obviated in known apparatus by arranging on the screen a foil which allows the reproduced image through in the direction of mirror 6 and blocks it in the direction of the user. This foil is however relatively expensive. According to the present invention the foil is unnecessary, since a user looks along the screen and only sees the image reproduced thereon displayed in reflected form as primary image in mirror 6.

A second embodiment (FIGS. 4 and 5) has a modified design. Videophone 50 comprises a support 52 with a front part 54 and a rear part 56 which are both provided with rubber feet 58 with which the videophone supports on a surface 60. The screen 62 arranged on support 52 (FIG. 5) forms an acute angle with the surface. The screen means of which screen 62 forms part comprise an elongation 64 which extends from an edge 66 of screen 62 to a pivot shaft 67. The pivot shaft connects the screen means hingedly to a cover 68 in which there is arranged a partly light-transmitting mirror 70, as in the above described first embodiment. Behind the mirror and received in cover 68 is arranged a camera, see for instance FIG. 3, for recording images through the mirror.

The screen arranged at an angle relative to the underside of support 52 provides a number of advantages compared to known videophones. A user is thus prevented from directly seeing the image reproduced by the screen, the secondary image, whereby an expensive foil blocking the light incidence in the direction of the user is unnecessary. A user does after all look along the screen and not onto it. The angle α (FIG. 3) particularly ensures however that the videophone is lower in the opened position (FIG. 5). During use the light incidence from the screen is directed obliquely upward and away from the user, wherein the mirror forms an angle β with the screen means (FIGS. 3, 4 and 5) to reflect the light to the eyes of the user. β is preferably a fixed angle in the order of 45°.

The above described advantages are further supplemented with the above mentioned advantages of displacing pivot shaft 67 further to the rear from edge 66, whereby the support can be lower while the image is still reflected at the desired height.

The advantages of the screen arranged at an angle α and the rearward displaced pivot shaft are preferably combined as shown in FIGS. 4 and 5.

In a further preferred embodiment, the videophone is equipped with a central processing unit which is coupled to, and drives, the screen, the camera, the microphone and the loudspeaker. The processing unit comprises a microprocessor and a memory with programs implemented in software or hardware.

The videophone preferably comprises a program which is stored in the memory of the processing unit and which transmits an identification when calling another videophone. The recipient party can then see who is calling, and decide whether to answer the call. The person who makes the call cannot see who is behind the called videophone. This is known as “caller ID”.

During a call a network connection is established in the background to indicate that the recipient party is being called. This takes place by means of protocols, such as the known Q.931 protocol for ISDN connections, or the H.225.0 protocol.

In practice the caller ID is implemented in two variants. In the first variant a reduced-size recording of the caller is made via an extension of the used protocol and then transmitted to the called videophone. In the second variant a second network connection, in which the recording made is transmitted in reduced size, is established in addition to the first connection. A network connection is here understood to mean a data flow over an existing connection.

The present invention is not limited to the above described preferred embodiments thereof, in which many modifications can be envisaged; the scope of protection sought is defined by the scope and extent of the appended claims.

1. Apparatus for communication with eye contact, comprising:
substantially flat image reproducing means for reproducing an image;
image recording means for recording an image;
mirror means arranged between the image reproducing means and the image recording means and comprising an at least partly light-transmitting, reflective surface for reflecting the image reproduced by the image reproducing means; and
a support, arranged on the underside of the image reproducing means, for supporting the apparatus on a surface therewith, wherein the image reproducing means form an acute angle α with the underside of the support.

2. Apparatus as claimed in claim 1, wherein the acute angle is in the order of 8°.

3. Apparatus as claimed in claim 1, wherein the angle is in the order of or smaller than 10°.

4. Apparatus as claimed in claim 1, wherein the mirror means are arranged in open position at an angle β to the image reproducing means, wherein β is of the order of 45°.

5. Apparatus as claimed in claim 1, wherein the mirror means are connected in a pivot shaft to the image reproducing means, wherein the pivot axis extends as low as possible above the plane of the image reproducing means and at a predetermined distance from an edge of the image reproducing means.

6. Apparatus as claimed in claim 4, wherein the predetermined distance is greater than 8 cm.

7. Apparatus as claimed in claim 4, wherein the predetermined distance is of the order of 10-15 cm.

8. Apparatus as claimed in claim 1 further comprising:
sound reproducing means; and
sound recording means for recording sound.

9. Apparatus as claimed in claim 1 further comprising a central processing unit to which are coupled the sound reproducing means, the sound recording means, the image recording means and/or the image reproducing means.

10. Apparatus as claimed in claim 1, wherein the image reproducing means comprise an LCD screen with an increased brightness of 1000-2000 Cd/m².

11. Apparatus as claimed in claim 1, wherein the at least partly reflective surface reflects about 50% of the incident light and allows through about 50% of the incident light.

12. Apparatus as claimed in claim 1 further comprising a coding/decoding unit for coding and decoding image and sound, and transmitting means for transmitting the coded image and sound.

13. Apparatus as claimed in claim 12, wherein the transmitting means has a bandwidth of 128 to 1024 kb/s.

14. Apparatus as claimed in claim 1, which during use makes a recording when calling another apparatus and transmits this to the other apparatus.

15. Apparatus as claimed in claim 1, with a width smaller than 800 mm and a depth smaller than 700 mm.

16. Apparatus as claimed in claim 9, wherein the processing unit is adapted to transmit an identification when calling another apparatus.

17. Apparatus as claimed in claim 16, wherein the sending of an identification takes place by establishing a network connection in the background in order to indicate by means of a protocol that the recipient party is being called.

18. Apparatus as claimed in claim 16, wherein the sending of an identification takes place via an extension of the used protocol, wherein a recording of a user can be sent to another apparatus.

19. Apparatus as claimed in claim 16, wherein the sending of an identification takes place through a second network connection, to be established in addition to a first network connection, for transmitting the recording of the user.

20. Apparatus for communication with eye contact, comprising:
substantially flat image reproducing means for reproducing an image;
image recording means for recording an image;
mirror means arranged between the image reproducing means and the image recording means and comprising an at least partly light-transmitting, reflective surface for reflecting the image reproduced by the image reproducing means, which mirror means are connected in a pivot shaft to the image reproducing means, wherein the pivot axis extends as low as possible above the plane of the image reproducing means and at a predetermined distance from an edge of the image reproducing means.

21.-22. (canceled)
